(19) United States
(12) Patent Application Publication
(10) Pub. No.: US 2026/0186322 A1
(43) Pub. Date: Jul. 2, 2026

(54) EYEWEAR SYSTEM

(71) Applicant: Apple Inc., Cupertino, CA (US)

(72) Inventor: Paul X Wang, Cupertino, CA (US)

(21) Appl. No.: 18/867,063

(22) PCT Filed: Jun. 23, 2023
(86) PCT No.: PCT/US2023/068947

§ 371 Date: Nov. 19, 2024

Related U.S. Application Data
(60) Provisional application No. 63/366,900, filed on Jun. 23, 2022.

(51) Int. Cl. G02C 5/12; G02C 5/14; G02C 11/00

(52) U.S. Cl. CPC G02C 5/122; G02C 5/143; G02C 11/10; G02C 2200/20

(57) ABSTRACT

An eyewear system includes a first securement arm, a second securement arm, and a lens frame defining an aperture for a lens, the lens frame connected to the first and second securement arms. The system also includes a nose pad connected to the lens frame, the nose pad comprising an adjustable grip enhancement system and an actuator that engages the adjustable grip enhancement system for additional grip with a nose in response to a sensed condition.

### CROSS-REFERENCE TO RELATED APPLICATION(S)

This application is a National Stage filing based off of PCT Application No. PCT/US 2023/068947, filed 23 Jun. 2023, and entitled “EYEWEAR SYSTEM” which claims priority to U.S. Provisional Ser. No. 63/366,900 , filed 23 Jun. 2022, and entitled “EYEWEAR SYSTEM,” the entire disclosure of which is hereby incorporated by reference.

### FIELD

The described embodiments relate generally to eyeglasses. More particularly, the present embodiments relate to retaining glasses in a desired position on the face of the wearer.

### BACKGROUND

Glasses are used in many situations to protect and improve our eyes, such as for correcting eyesight, for shielding from UV light and glare, and for protecting eyes from possible injury at work or while playing sports. For those who need to wear glasses, especially for a long time, the comfort of the glasses is a significant consideration. For glasses to perform the intended function, a proper fit to the user's face is preferred. Every user has a different face shape. As such, glasses traditionally include nose pads so that the glasses are positioned correctly and can be adjusted or otherwise fit to the wearer's face. However, glasses having nose pads can still easily slide down the wearer's nose due to sweat, as sweat is often unavoidable while the wearer works or exercises. When traditional nose pads fall from their original position, the wearer usually feels discomfort and is compelled to adjust the position of their glasses.

Further, the potential loss of glasses during sports or other activities can be troublesome because glasses can be expensive and active motion provides ample opportunity for the glasses to fall from the wearer's face. In an attempt to mitigate the problem of having glasses inadvertently come off, some designs include straps which attach to the glasses and which, to some degree, secure the glasses to the wearer and help prevent their loss. However, the straps can be uncomfortable and also do not address the constant adjustment due to glasses repositioning or slipping. Straps on the glasses can also be considered unfashionable.

### SUMMARY

According to some examples of the present disclosure, an eyewear system can include a first securement arm, a second securement arm, and a lens frame defining an aperture for a lens, the lens frame connected to the first and second securement arms. The eyewear system can also include a nose pad connected to the lens frame, the nose pad including an adjustable grip enhancement system for selectively modifying a grip with a nose. In some examples, the eyewear system can include an actuator that engages the adjustable grip enhancement system in response to a sensed condition.

In some examples, the nose pad can include directional protrusions and the nose pad can be adapted to selectively pivot with respect to the lens frame to adjust a grip on a nose of a wearer. The actuator can include a sensor configured to detect a slip parameter. In some examples, the eyewear system can further include a protrusion disposed on the nose pad and the actuator can selectively extend the protrusion.

According to some examples, the adjustable grip enhancement system can include a woven fabric including polyurethane, polyvinyl chloride, a silicone material, or a shape memory alloy. In some examples, the adjustable grip enhancement system can include a polymer having micro-indentation fibrils extending in ridges from the surface of the nose pad. In some examples, the adjustable grip enhancement system can include a removable nose pad cover. In other examples, the grip enhancement system can be integrated with the lens frame.

An eyewear system for improved stabilization can include an optical lens, a frame supporting the optical lens, a nose pad connected to the frame, a sensor configured to monitor an engagement of the nose pad with a nose, and a grip enhancement system that selectively modifies the eyewear system to grip the nose in response to a signal from the sensor. In some examples, the nose pad can include a first nose pad and the eyewear system further includes second nose pad and a spring disposed in the frame. According to some examples, the grip enhancement system causes a pinch force between the first and second nose pads and a nose of a wearer and the spring providing a variation in distance between the first and second nose pads of between about 2 mm and about 8 mm.

In some examples, the sensor can include a pressure sensor disposed in the nose pad. In other examples, the sensor can include an accelerometer associated with the frame. The sensor can include a moisture sensor or a thermal sensor. In yet other examples, the sensor can include an eye tracking camera disposed in the frame or a counter that determines a number of adjustments of the frame. According to some examples, the eyewear system can further include an extendable earpiece connected to the frame.

An eyewear system can include an adjustable grip enhancement system, the grip enhancement system having a first configuration and a second configuration. The eyewear system can also include a sensor configured to detect a slip parameter. The grip enhancement system can adjust from the first configuration to a second configuration in response to the detected slip parameter to provide additional grip with the nose. In some examples, the eyewear system can include a portable electronic device communicatively connected to the grip enhancement system. The first configuration and the second configuration can be adjusted on the device in response to the detected slip parameter. In some examples, the portable electronic device can further include a display configured to indicate when the adjustable grip enhancement system adjusts configurations. According to some examples, the slip parameter can include a wearer selecting a configuration or a condition detected by the eyewear system.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a front view of a wearer using an eyewear system.

FIG. 2 shows an enlarged view of a nose pad of an eyewear system.

FIG. 3 shows a cross-sectional view of a removable nose pad.

FIG. 4A shows a surface of the nose pad including a grip enhancement system for additional grip with a nose.

FIG. 4B shows a cross-sectional view of the nose pad of FIG. 4A.

FIG. 4C shows a surface of the nose pad including a grip enhancement system for additional grip with a nose.

FIG. 4D shows a cross-sectional view of a nose pad including a removable cover.

FIG. 4E shows a surface of the nose pad including a grip enhancement system for additional grip with a nose.

FIG. 5A shows a partial view of a nose pad of an eyewear system including a sensor.

FIG. 5B shows a cross-sectional view of a nose pad including a grip enhancement system for additional grip with a nose and an actuator.

FIG. 6 shows a partial view of an eyewear system including an eye-tracking camera.

FIG. 7 shows a partial cross-sectional view of an eyewear system having a spring disposed in the frame and also extendable earpieces connected to the frame.

FIG. 8 is a flow chart of a method of securing eyewear.

### DETAILED DESCRIPTION

Reference will now be made in detail to representative examples illustrated in the accompanying drawings. The following descriptions are not intended to limit the embodiments to one preferred embodiment. Rather, it is intended to cover alternatives, modifications, and equivalents as can be included within the spirit and scope of the described embodiments as defined by the appended claims.

The following disclosure relates to an eyewear system, such as smart glasses, that include a contact system that improves the stabilization of the eyewear when worn. The disclosed eyewear system solves fundamental challenges faced by conventional glasses by providing at least the following advantages. First, the system allows greater control over lens placement. Especially for those involved in sports or an active lifestyle, wearers of glasses can constantly be adjusting the frames because glasses slip down the nose due to low friction nose pads or a lack of nose pads and sweat. The disclosed systems and methods are calculated to address the slipping of the frames. Second, the eyewear systems and methods are comfortable to the wearer and fashionable. Other systems are available to ensure glasses stay in place on a wearers head. For example, eyewear having straps or that pinch the sides of the head are designed to prevent the eyewear from falling off, but are also either uncomfortable or unsightly. Some solutions envisioned to prevent slipping are obvious to others and too noticeable. Lastly, the eyewear systems and methods can be either static or dynamic. Each of these benefits are discussed in detail.

Wearers of glasses can have a dynamic lifestyle. For example, the wearer can engage in an intense exercise routine in the morning prior to sitting comfortably at work and then again engaging in a sport activity after work. Given the lifestyle of glasses wearers, an eyewear system for improved stabilization can include several innovations that incorporate smart features and/or advanced materials to provide additional grip with the nose of the wearer. The present disclosure provides means for incorporating smart and/or dynamic systems for improved performance.

The eyewear system can include a static grip enhancement system for additional grip with a nose. In some examples, the static grip enhancement system can include a “smart” material that enhances grip. In some examples the material can include a fabric and/or a coating that changes behavior based on water absorption. According to some examples, the static grip enhancement system can include a woven fabric. The nose pads can be removable and/or interchangeable or can be integrated with the lens frame. Further details regarding the attachment interfaces are provided below.

In some examples, the eyewear system can include a dynamic grip enhancement system. The grip enhancement system can provide the advantage of changing the grip in response to conditions or as desired by the wearer. The wearer can know when slipping conditions are likely to occur and can adjust the system accordingly. In other examples, the system can detect at least one condition when enhanced grip is required and/or desired and adjust automatically. The eyewear system can include at least one sensor that can monitor a parameter that affects the grip of the nose pads with the wearer's nose. For instance, the sensor can include a counter that determines a number of adjustments of the frame by the wearer. In other words, the eyewear system detects when the grip should be strengthened based on the number of times the frame slips down and needs to be corrected, and the eyewear system improves the grip of the grip enhancement system accordingly. Further details regarding the dynamic and/or adjustable grip enhancement system are provided below.

Although the focus of the disclosure relates to the system being used to enhance grip with the nose, it will be understood that the eyewear system can be used for a variety of situations and include other components and accessories. The eyewear system can improve grip using other methods not limited to the nose. Other grip enhancing features, systems, or methods can be integrated into the eyewear system.

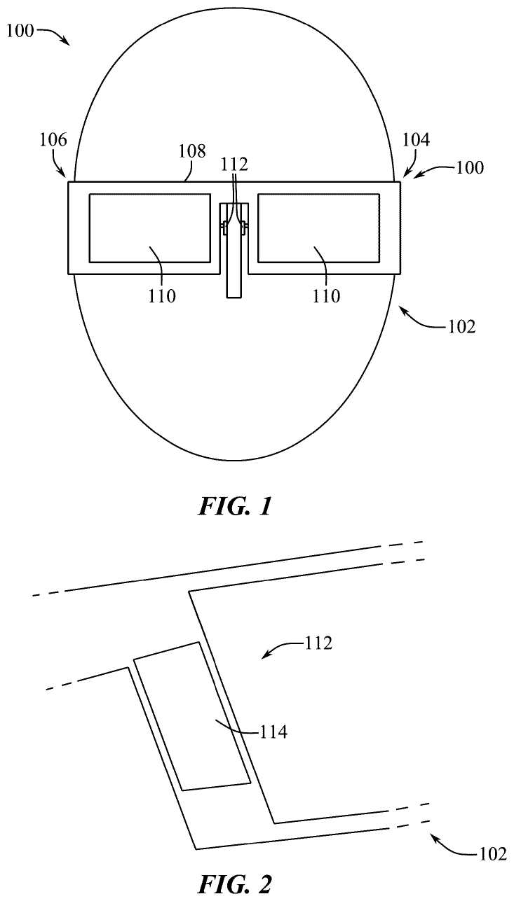

These and other embodiments are discussed below with reference to FIG. 1 8. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a front view of a wearer using an eyewear system 100. The eyewear system 100 can include an assembly 102 having a first securement arm 104, a second securement arm 106, and a lens frame 108 defining an aperture for a lens 110. The eyewear system 100 can also include a nose pad 112 connected to the lens frame 108. In some examples, the eyewear system 100 can be modular (i.e., the nose pad 112 can be detachable and separable from one another). In some examples, the eyewear system 100 can be at least partially a unitary device (i.e., the nose pad 112 can be integrally formed and configured to be permanently attached to the lens frame 108).

It will be understood that only select components are shown and described in FIG. 1 for simplicity. The assembly 102 is not limited to these components and may include additional components not shown or described herein. In some examples, the assembly 102 can be included in a head mounted display (HMD). The eyewear system 100 can be used in a virtual reality and/or alternate reality (VR/AR) headset. The HMD can be heavier on the head of the wearer than standard eyeglasses. In some examples, to help maintain the proper orientation of the HMD, the assembly 102 and the nose pad 112 can be included.

In some examples, the assembly 102 can include prescription glasses. The lens 110 can be customized and/or specific to the wearer. The lens 110 can be configured to correct an eye disorder (e.g., myopia). In some examples, the assembly 102 can be sunglasses and/or safety glasses. The assembly 102 can be configured for sports, active gaming, and/or high intensity activity. The assembly 102 can include a replaceable lens 110 and/or other features tailored uniquely for the activity and vision needs of the wearer. In some activities, the assembly 102 can slide or otherwise reposition on the face. The systems and methods described in further detail below, can minimize and/or prevent the loss of grip due to motion, sweat, and/or moisture.

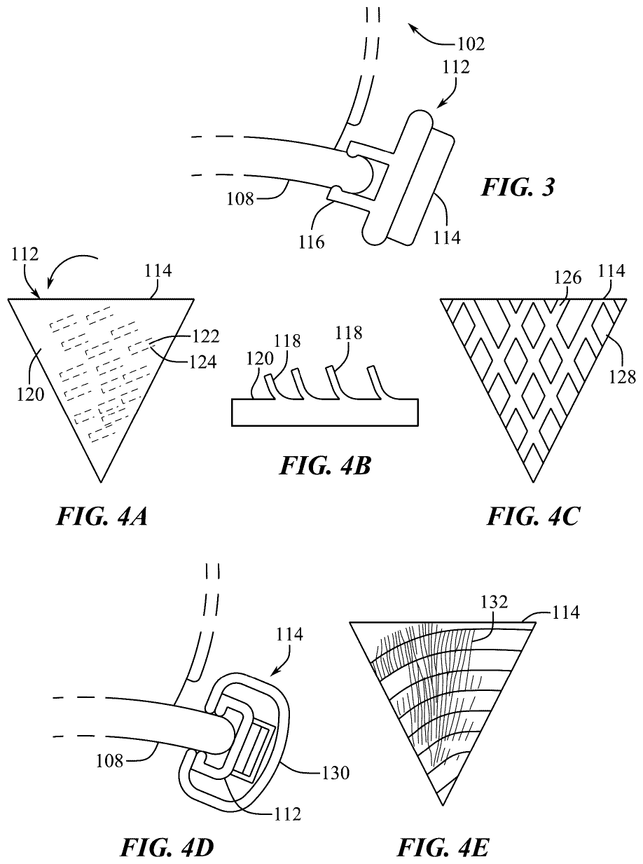

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Further details regarding the assembly 102 and nose pad 112 are provided below with reference to FIGS. 2-3.

FIG. 2 shows an enlarged view of the nose pad 112 of the eyewear system 100. In some examples, the nose pad 112 can include a grip enhancement system 114. The grip enhancement system 114 can be integrated with the lens frame 108. In other words, the grip enhancement system 114 can be a permanent feature of the lens frame 108. In other examples, the grip enhancement system 114 can be removable and/or interchangeably connected to the assembly 102.

In some examples, the grip enhancement system 114 can be a static system. In other words, the additional grip provided by the grip enhancement system 114 can include a material property or feature that is immobile or stationary. Benefits of a static system can include simplicity and ease of maintenance. Because the static system does not include moving parts or electronic components, the grip enhancement system 114 is less likely to degrade over time and does not require a power source. In some examples, the static grip enhancement system 114 can include a low profile. The grip enhancement system 114 can be disposed into the lens frame 108 and be flush with the frame. In some examples, the grip enhancement system 114 can be flush with the lens frame 108 and interchangeable. In some examples, the grip enhancement system 114 can be interchangeable from a static system to a dynamic system.

FIG. 3 shows a cross-sectional view of a removable nose pad 112. In some examples, to ensure the grip enhancement system 114 is positioned as required, the nose pad 112 can be interchangeable. In some examples, the nose pad 112 can include a clamp, a snap, and/or a magnet to secure the nose pad 112 to the lens frame 108. The nose pad 112 can include various types of grip enhancement systems 114 for additional grip with the nose. In some examples, the nose pad 112 can be interchanged with another nose pad 112 that extends further towards the face of the wearer. In some examples, the nose pad 112 that includes a static grip enhancement system 114 can be interchanged with another nose pad 112 that includes a dynamic and/or adjustable grip enhancement system 114. The nose pad 112 can include connector 116. In some examples, the connector 116 can extend from the nose pad 112 and be configured to secure with a portion of the lens frame 108. In some examples, the nose pad 112 can be adjustable for a customizable fit to the face of the wearer. Having the nose pad 112 be interchangeable can make the grip enhancement system 114 more effective. In some examples, the nose pad 112 can include components optimized at the manufacturer for a fit and can reduce adjustments required by the wearer and/or fine-tuning adjustments. For example, the nose pad 112 can have a first orientation configured for comfort and a second orientation for active situations, such that the grip enhancement system 114 can have a better grip for active situations.

Any of the features, components, and/or parts, including the arrangements and configurations thereof shown in FIGS. 2-3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2-3. Further details regarding grip enhancement system 114 are provided below with reference to FIGS. 4A-4E.

Referring now to FIG. 4A-4B, a surface of the nose pad 112 is adapted to selectively pivot with respect to the lens frame 106. In some examples, pivoting the nose pad 112 can cause directional protrusions 118 to adjust a grip on the nose of a wearer of the eyewear system 100. In some examples, the protrusions 118 can cover the surface of the nose pad 112 that grip the nose of the wearer.

The protrusions 118 can include any suitable material and design. In some examples, the protrusions can include non-attached portions of a surface layer 120 of the nose pad 112. For example, as shown in FIG. 4B, the protrusions 118 can include non-attached portions of the surface layer 120 of the nose pad 112. In some examples, the protrusions 118 are secured by attachment to the surface layer 120 of the nose pad 112. In other examples, the protrusions 118 are portions of the surface layer 120 that have been cut out and biased to extend from the surface layer 120 when oriented for additional grip. For example, the protrusions 118 do not overlap in a first direction but are flush to the nose pad 112. When pivoted, the protrusions 118 are biased to extend from the surface layer 120 of the nose pad 112 to grip the nose of the wearer. The protrusions 118 can reduce local surface area. In other words, the protrusions 118 prevent a meniscus layer of water and/or sweat from forming on the skin.

The protrusions 118 can be of any suitable shape. The shape of the protrusion 118 may be described by a cutout 122 formed along the edges of the protrusion and not connected to the surface layer 120. The cutout 122 can be an edge line 124. In other words, the protrusion 118 has an edge line 124. The protrusions 118 can include edge lines 124 that can be curved lines, straight lines, or combinations thereof.

In some examples, the protrusions 118 can include a texture. For example, the texture can be included as a coating or cutout from the surface layer 120. Any suitable type of texture can be included. For example, texturing having bulges, scars, notches, grooves, punctures, or combinations thereof can be on the surface layer 120 of the grip enhancement system 114. The texture can further prevent slipping, especially in humid environments or with sweat. Additionally or alternatively, the texture can provide tactile means for determining rotation of the protrusions 118.

The protrusions 118 can include any suitable appearance. The protrusions 118 can be opaque, light scattering, transparent, or a combination thereof. The protrusions 118 can extend from the surface layer 120 between about 1 μm and about 1 mm. In some examples, the protrusions 118 can include sharp pointed ends that grip enhancement the skin, in other examples, the ends of the protrusions 118 can be rounded. The protrusions 118 extending from the surface layer 120 reduce the grip enhancement surface of the nose pad 112. The protrusions 118 increase the surface of the nose pad 112 to make it rough, which results in an increase in friction. The rough surface of the nose pad 112 provides more grip on the nose and reduces slip.

In some examples, the wearer of the assembly 102 controls the rotation of the nose pad 112. For example, the nose pad 112 can include a rotating connector (not shown) to connect the nose pad 112 to the lens frame 108. In some examples, the nose pad 112 can rotate to engage the protrusions 118 to the nose. For example, the nose pad 112 can be rotated such that the cutout 122 is directed downward, so that inertia and/or gravity can help engage the protrusions 118 to the skin of the wearer. In some examples, the nose pad 112 can lock in a first configuration with the protrusions 118 withdrawn or flat and then be rotated to lock in a second configuration with the protrusions 118 extended.

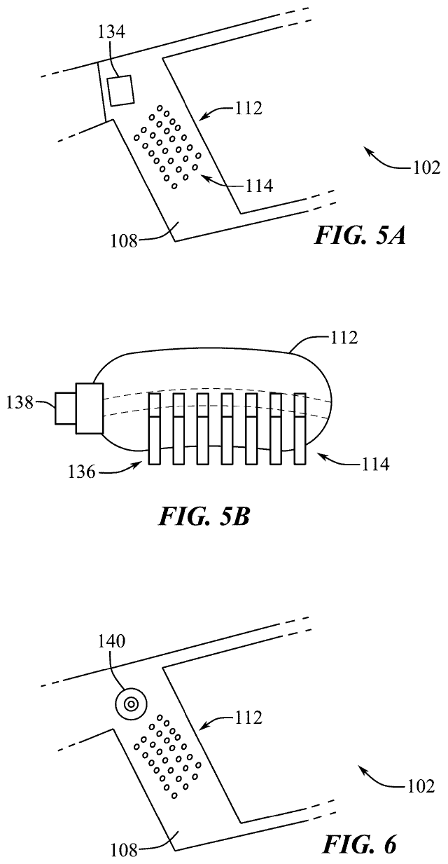

In some examples, the grip enhancement system 114 can be configured to automatically rotate when a condition is present that requires an additional grip with the nose. In some examples, the eyewear system 100 can include an actuator that engages the grip enhancement system 114 in response to a sensed condition. In some examples, the condition can be detected with a sensor, as described in more detail below with reference to FIGS. 5A-5B. In some examples, the rotation can be remotely operated via a companion device communicatively connected with the assembly 102 via a communications link. The communications link can be a physical connection, such as an electrical wire, or can be a wireless connection, such as Bluetooth, WI-Fi, proximity sensors, etc. The companion electronic device (not shown) can be a remote, or a portable electronic device such as a smart phone, a smart watch, a tablet, or any other form of electronic device.

Referring now to FIG. 4C, in some examples, the grip enhancement system 114 can include an outer layer 126 and an inner section, in the example shown, an inner layer 128. Outer layer 126 can be disposed over the inner layer 128, which is in turn disposed over the nose pad 112. In some examples, the durometer of inner layer 128 can be higher than the durometer of the outer layer 126. For example, the inner layer 128 can be formed from a plastic, while the outer layer 126 is formed from a rubber material, a polyurethane, a polyvinyl chloride (PVC) material, a silicone material, or a closed cell foam. The outer layer 126 can include any suitable material configured to increase friction between the grip enhancement system 114 and the nose of the wearer.

In some examples, the grip enhancement system 114 can include a woven fabric. The woven fabric can include the inner layer 128 and the outer layer 126. The woven fabric can include a polyurethane, PVC material, a silicone material, or a shape memory alloy. Various durometers of the fabric material may be employed such that it may take considerable effort to reshape and the woven fabric can be durable. In some examples, the woven fabric can include a mesh. The fabric mesh can be stitched to form a multi-layered grip including the outer layer 126 and the inner layer 128. The outer layer 126 can be a fabric layer coated and/or saturated by polyurethane or other suitable material. In some examples, the polyurethane coating the outer layer 126 can be between about 0.1 and 0.4 millimeters thick as measured from a surface of the outer layer 126. In some examples, the polyurethane coating the fabric layer is between approximately 0.15 and 0.25 millimeters thick. In one aspect, the polyurethane coating the fabric layer can be about 0.2 millimeters thick.

In some examples, the woven fabric can include a shape memory alloy. The shape memory alloy can adjust shape to the wearer's nose and then memorize the shape to improve the grip of the woven fabric. In some examples, the shape memory alloy can be included in either the inner layer 128, the outer layer 126, or both layers. The grip of the woven fabric can be adjusted by heating or cooling the shape memory alloy, or by an electrical current. The two most prevalent shape-memory alloys are copper-aluminum-nickel and nickel-titanium (Nitinol), but other shape memory alloys can be included in the woven fabric. When a shape-memory alloy is in its cold state (i.e., below the transition temperature), the alloy can be bent or stretched and holds the shape until heated above the transition temperature. Upon heating, the shape changes to its original. When the metal cools again, it will retain the shape, until deformed again. For example, when the metal is heated, the shape of the alloy can be configured on the nose pad 112 to provide additional grip with the nose and when the metal is cooled, the shape can be configured to rest, when additional grip is not required.

FIG. 4D shows a cross-sectional view of the nose pad 112 including a removable cover 130. Similar to the above embodiments, the grip enhancement system 114 can be transitioned to include additional grip with the nose of the wearer. The removable cover 130 can include any of the features and methods for additional grip as described above with reference to FIGS. 2-4C. In some examples, the removable cover 130 can be made of a woven or non-woven fabric. In other examples, the removable cover 130 can be more durable. The removable cover 130 can include a silicone material that stretches over the nose pad 112. In some examples, the removable cover 130 can be a plastic or metal cover that removably connects to the nose pad 112. The removable cover 130 can include a static, dynamic, and/or adjustable grip enhancement system 114.

FIG. 4E shows another surface of the nose pad 112 that includes a grip enhancement system 114 for additional grip with a nose. The grip enhancement system 114 of FIG. 4E can include a polymer material having micro-indentation fibrils 132. The fibrils can extend in ridges from a surface of the nose pad 112. In some examples, the grip enhancement system 114 can be configured to model “gecko feet.” The gecko is a pad-bearing lizard. The gecko's toe includes a pad made up of rows of lamellae about 400-600 μm, that run roughly perpendicular to the gecko's normal direction of motion. The distal, exposed portion of the lamellae is covered with setae. There are roughly 14,400 setae per mm. In the gecko foot, each setae begins at a diameter of roughly 5 microns and then decreases in width at branch points before ending in multiple protrusions, which each terminate with a flattened portion.

FIG. 4E shows an example of the grip enhancement system 114 modeling the gecko feet. The micro-indentation fibrils 132 can include diameters of about 0.1 μm. In some examples, the fiber can be flexible and the nose pad 112 can further include a flexible material so that the tips of individual fibrils can act together and attach to the uneven surfaces of the nose at the same time. The fibrils 132 can include polymethyl methacrylate (PMMA). Other suitable polymer materials can include polyacrylonitrile (PAN), polyetherketone, polyimide, an aromatic polymer, or an aliphatic polymer. Potentially, the fibrils 132 could also be biological in nature, such as protein, carbohydrate, lipid, or various combinations of the above.

In some examples, the fibrils 132 can also be functionalized by adding one or more functional groups (e.g., a chemically reactive group). These groups can chemically interact with the surface, either through Van Der Waal (VDW) forces, friction, or by binding covalently with a chemical group on that surface or increase the dielectric constant of the nanofiber, which increases the VDW attraction between the nanofiber and the surface to which it is grip enhanced. In some examples the functional groups can decrease the VDW attraction between the nanofiber and the surface (e.g., in uses which require a weaker adherence than would otherwise result without the group) and/or increase or decrease friction forces between the nanofibers and opposing surfaces.

Any of the features, components, and/or parts, including the arrangements and configurations thereof shown in FIGS. 4A-4E can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4A-4E. Further details regarding the eyewear system 100 and grip enhancement system 114 are provided below with reference to FIGS. 5A-5B.

FIG. 5A shows a partial view of the nose pad 112 of the eyewear system 100 including a sensor 134. The sensor 134 can monitor a slip parameter that may affect the grip of the nose pad 112 with the nose of the wearer. The grip enhancement system 114 can then adapt the eyewear system 100 to grip the nose. In some examples, the nose pad 112 can dynamically extend protrusions to improve the grip of the eyewear system 100. In some examples, the sensor 134 can be disposed in the lens frame 108. The sensor 134 can be electronically connected to the grip enhancement system 114. In some examples, the sensor 134 can be disposed remotely and operated via a companion device communicatively connected to the assembly 102 via a communications link. The communications link can be a physical connection, such as an electrical wire, or can be a wireless connection, such as Bluetooth, WI-Fi, proximity sensors, etc. The companion electronic device (not shown) can be a remote, or a personal computing device such as a smart phone, a smart watch, a tablet, or any other form of electronic device.

In some examples, the sensor 134 can detect an environment or surface condition of the wearer of the assembly 102 and adjust the grip enhancement system 114. In other words, the sensor 134 can be responsive to the surroundings or the body conditions of the wearer. The sensor 134 can collect information about the wearer or the wearer's external environment (e.g., weather information, body temperature, heart rate, etc.). The sensor 134 can provide the collected information to a processor disposed within the assembly 102 or remotely connected to the eyewear system 100.

In some examples, the sensor 134 can include a pressure sensor disposed in the nose pad 112. A pressure sensor can include an instrument having a pressure sensitive element to determine the actual pressure applied to the sensor (using different working principles) and components (not shown) that convert this information into an output signal. In some examples, the sensor 134 can include a diaphragm configured to deform when pressure is applied. According to some examples, the pressure sensor can detect when the nose pad 112 is slipping from the nose because the pressure exerted on the nose pad 112 by the nose decreases. Upon reaching a predetermined threshold and/or a series of pressure changes, the sensor 134 can signal the grip enhancement system 114 to increase the grip.

In some examples, the sensor 134 can include an accelerometer disposed in the lens frame 106. The accelerometer can include an electromechanical device used to measure acceleration forces. Such forces can be dynamic to sense movement and/or vibrations. In some examples, the accelerometer can include a piezoelectric material which produces an electrical charge that is proportional to the force exerted upon it. Since the charge is proportional to the force, and mass is a constant, then the charge is also proportional to the acceleration. The accelerometer can detect motion and/or vibration and then signal the grip enhancement system 114 to increase the grip of the grip enhancement system 114 on the nose.

In some examples, the sensor 134 can include a counter that determines a number of adjustments of the lens frame 108 by the wearer. In some examples, the counter can be electronically coupled to the accelerometer described above that senses the motion of the eyeglass system 100. In some examples, the counter can be located in a companion device (not shown) such as a smart watch that counts the number of arm raises of the wearer to determine the adjustments. The counter can include a minimum threshold of counts prior to changing the grip of the grip enhancement system 114.

In some examples, the sensor 134 can include a moisture sensor. In some examples, the moisture sensor can detect if there is water and/or sweat in grip enhancement with the sensor 134 and then signal the grip enhancement system 114 to increase the grip of the grip enhancement system 114 on the nose. In some examples, the moisture sensor can measure the presence of water indirectly by using some other property of sensor, for example, electrical resistance or dielectric constant as a proxy for the moisture content. In some examples, the moisture sensor can detect a threshold humidity value and signal the grip enhancement system 114 to increase the grip of the grip enhancement system 114 on the nose.

In some examples, the sensor 134 can include a thermal sensor. Because the grip of the assembly 102 on the nose can be affected by sweat and sweat is formed in higher temperatures, a thermal sensor can be used to predict needed additional grip. In some examples, when the ambient temperature crosses a predetermined limit, the thermal sensor can signal the grip enhancement system 114 to increase the grip of the grip enhancement system 114 on the nose. In some examples, the thermal system can include a thermocouple. Thermocouples work on the principle of the Seebeck effect—the phenomenon in which the temperature difference between two dissimilar metal wires produces a voltage difference. The voltage difference is proportional to the temperature change. In other examples, the thermal sensor can include a resistance temperature detector (RTD). In RTDs, change in resistance is used for sensing temperature. RTDs require that materials have a well-defined resistance-temperature relationship. Platinum is considered the best material for RTDs because of its linear relationship between resistance change and temperature variation. Platinum RTDs are stable, accurate, and have repeatability in measurement. However, other materials can be used in RTDs, for example nickel and copper, but the accuracy is lower with these metals. In some examples, the thermal sensor can include an infrared (IR) sensor. IR sensors are electronic sensors that detect temperature by emitting IR radiations. They are non-grip enhancing type thermal sensors.

Each of the types of sensors can be used to detect a slip parameter that the grip enhancement system 114 can adjust for. The slip parameters can include pressure, motion, moisture content at the skin surface and/or the environment, and temperature. The slip parameters cause the eyewear system 100 to slip or adjust. The grip enhancement system 114 can then adjust from a first configuration to a second configuration. The second configuration can be aligned for additional grip with the nose of the wearer. In some examples, the sensor 134 can be configured to monitor an engagement of the nose pad 112 with a nose, and the grip enhancement system 114 then selectively modifies the eyewear system 100 to grip the nose in response to a signal from the sensor 134.

FIG. 5B shows a cross-sectional view of the nose pad 112 including grip enhancement system 114 for additional grip with the nose. In some examples, the grip enhancement system 114 can include extendable protrusions 136 that are adjustable between the first configuration and the second configuration. In some examples, the first configuration has the extendable protrusions 136 retracted into the nose pad 112. For example, FIG. 5A shoes the nose pad 112 having extendable protrusions 136 retracted. FIG. 5B shows the grip enhancement system 114 in the second configuration. The second configuration can include the extendable protrusions 136 extending from the nose pad 112 to provide additional grip with the nose. In some examples, the extendable protrusions 136 can be extended by inertia. In other words, in response to motion or vibration, the extendable protrusions 136 can be drawn out of the nose pad 112. The nose pad 112 can include a light spring coupled to the protrusions 136 to maintain the normal force when the protrusions 136 are extended. In some examples, the extendable protrusions 136 can lock into the second configuration by friction or an interference fit. The extendable protrusions 136 can then be retracted back into the nose pad 112 with force or an actuator.

In some examples, the grip enhancement system 114 can include an actuator 138. The actuator 138 can be disposed on the assembly 102 or on the nose pad 112. The extendable protrusions 136 can extend from a surface of the nose pad 112 when the actuator 138 engages. The actuator 138 can engage the adjustable grip enhancement system 114 in response to a sensed condition. In some examples, the actuator 138 can include a mechanical system. The actuator 138 can be a button or a twist knob that can be engaged by the wearer. Upon engagement of the actuator 138, the extendable protrusions 136 can extend from the first configuration within the nose pad 112 to the second configuration. The actuator 138 can include any suitable mechanical system. In some examples, the actuator 138 can include a simple grip enhancement within the nose pad 112 that is connected to the actuator 138 and causes extendable protrusions 136 to extend. In some examples, the surface of the nose pad 112 can be compressible that causes a stationary protrusion to extend from the surface. In other words, the nose pad 112 can include a push-push latch. The push-push latch can include springs located inside the nose pad 112 to extend either the nose pad 112 or the protrusions 136 and which, when pressed, activate the spring and extend and/or retract the nose pad 112 or the protrusions 136. In other examples, the actuator 138 can include a motor. The motor can be electronically connected to a sensor (e.g., sensor 134) or can communicate with a remote device. In some examples, the remote device can include a selection of the first configuration and the second configuration. The wearer can select the desired first or second configuration on the device in response to a parameter to adjust the grip enhancement system between the first or second configuration. In some examples, the eyewear system 100 can further notify the wearer of the device when the eyewear system 100 adjusts configurations.

Any of the features, components, and/or parts, including the arrangements and configurations thereof shown in FIGS. 5A-5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A-5B. Further details regarding the eyewear system 100 and grip enhancement system 114 are provided below with reference to FIG. 6.

FIG. 6 shows a partial view of the eyewear system 100 including an eye-tracking camera 140. The eye-tracking camera can be disposed in the lens frame 108 of the assembly 102. In some examples, the eye tracking can include capturing and/or measuring either the point of gaze (where one is looking) or the motion of an eye relative to the head. The retina of the eye includes an area of dense nerves and high-visual acuity called the fovea. The lens of the eye focuses light on the fovea, and muscles moves the eyes to direct the lens and fovea where they want to look. The eye-tracking camera 140 can be used for measuring eye positions and eye movement. The wearer can adjust the grip enhancement system 114 from the first configuration to the second configuration with eye motion. Further, the eye tracking camera 140 can detect a parameter from the wearer that can be used to adjust the grip enhancement system 114. For example, the eye tracking camera 140 can detect humid conditions, exertion, tears, and/or sweat.

In some examples, the eye tracking camera 140 can be mounted in the lens frame 108 so that the eye tracking camera 140 has an unobstructed view of the eye of the wearer. The positioning in the lens frame 108 can provide a good angle to the parts of the eye required for tracking without obstruction from the eye lashes or other impediments. The eye tracking camera 140 can be electronically connected to a sensor (e.g., sensor 134 shown in FIG. 5A). The sensor 134 can receive an image from the camera 140 and determine the gaze point of the eye of the wearer. In other words, the sensor can be responsive to an eye movement of the wearer. The sensor 134 can provide the collected information to the grip enhancement system 114 for adjustments or the eye tracking camera 140 and/or sensor 134 can be remotely connected to a remote device (not shown). In some examples, the camera 140 can be configured specifically for eye-tracking and include properties to reduce the weight and improve the accuracy of the eyewear system 100.

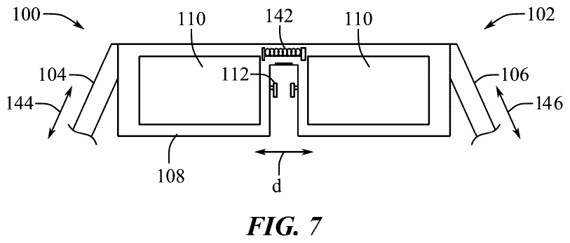

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Further details regarding the eyewear system 100 and grip enhancement system 114 are provided below with reference to FIG. 7.

FIG. 7 shows a partial cross-sectional view of eyewear system 100 having a spring and/or piston 142 disposed in the lens frame 108. In some examples, the grip enhancement system 114 can use the spring 142 to cause a pinch force between the nose pads 112 and the nose of the wearer. In some examples, the spring 142 can provide a variation in distance, “d”, between the nose pads 112. The distance “d” can vary between about 2 mm and about 8 mm. The variation in distance can cause the nose pads 112 to grip the nose tighter. In other words, the eyewear system 100 can adjust from a first configuration having a relatively longer distance “d” between the nose pads 112 to a second configuration having a relatively shorter distance “d” between the nose pads 112.

In some examples, the spring 142 can be controlled by an actuator (e.g., actuator 138 shown in FIG. 5B). The wearer can engage the actuator 138 and cause the distance “d” to shorten. In other examples, the spring 142 can be controlled by a sensor (e.g., sensor 134 shown in FIG. 5A). In response to a parameter, the grip enhancement system 114 can cause the pinch force and improve the grip of the grip enhancement system 114.

In some examples, the assembly 102 can include extendable earpieces connected to the lens frame 108. The extendable earpieces 144 and 146 can be integrated into the first securement arm 104 and the second securement arm 106, respectively. In other words, the first securement arm 104 and the second securement arm 106 can be extendable. The extendable earpieces 144, 146 can be configured to extend from a first configuration to a second configuration to shift the center of gravity of the assembly 102 closer to the face of the wearer. In some examples, the shifting of the center of gravity of the assembly secures the assembly 102 to the wearer.

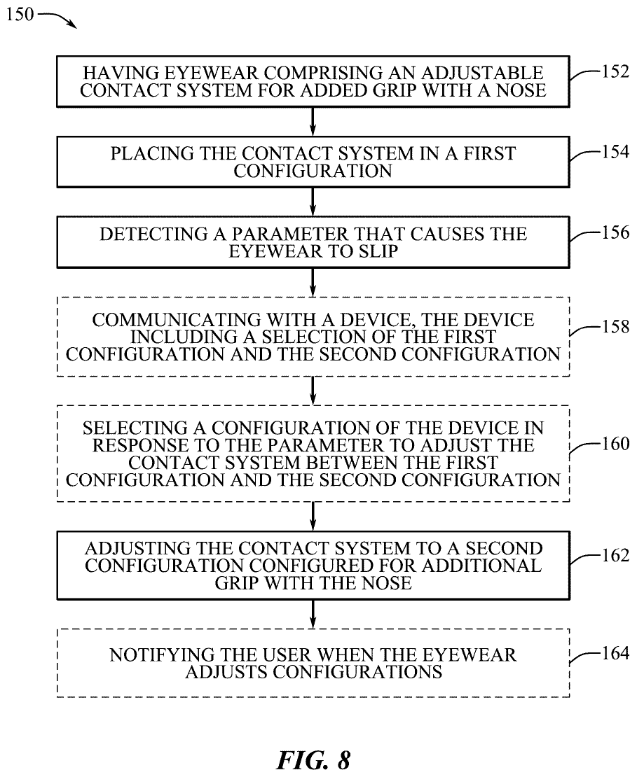

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7. Further details regarding the eyewear system 100 and grip enhancement system 114 are provided below with reference to FIG. 8.

FIG. 8 is a flow chart of a method 150 of securing the eyewear system 100. In some examples, the method 150 can include an act 152 of having eyewear with an adjustable grip enhancement system, with the grip enhancement system in a first configuration. In some examples, the adjustable grip enhancement system can include grip enhancement system 114 in any of the examples and/or embodiments described above. The method can include an act 154. In act 154, the grip enhancement system can be in a first configuration. The first configuration can include the eyewear system 100 in a normal configuration. In other words, no additional force or engagement with the nose of the wearer. The method 150 can further include an act 156 of detecting a slip parameter that causes the eyewear to slip. In some examples, the detection can be by the wearer. Other examples can include sensors that detect the slip parameter disposed in an assembly of the eyewear system 100. In some examples, the slip parameters can include any condition that affects the grip of the nose pads with a nose. Parameters can include moisture content on the skin of the wearer or in the surrounding environment, temperature, motion, etc.

In some examples, method 150 can include an act 158 of communicating with a device. In some examples, the device can include a companion device communicatively connected to the assembly via a communications link. The communications link can be a physical connection, such as an electrical wire, or can be a wireless connection, such as Bluetooth, Wi-Fi, proximity sensors, etc. The companion portable electronic device (not shown) can be a remote, or a personal computing device such as a smart phone, a smart watch, a tablet, or any other form of electronic device. The device can include a selection of the first configuration and the second configuration. In some examples, the method 150 can optionally include act 160. In act 160, the wearer can select a configuration on the device in response to the parameter to adjust the grip enhancement system of the eyewear system 100 between the first configuration and the second configuration.

In some examples, the method 150 can include an act 162 of adjusting the grip enhancement system to the second configuration. The second configuration can include the examples and systems above that provide additional grip with the nose of the wearer. Act 162 can include the adjustable grip enhancement system adjusting automatically in response to a parameter or can include a manual adjustment (e.g., a manual actuator). In some examples, the method 150 can include an act 164 of notifying the user when the eyewear adjusts configurations. In some examples, the notification can include an alert on the eyewear system or a remote device.

To the extent applicable to the present technology, personal information data can be used to the benefit of users and the enhancement of the technology. However, if used, the gathering, storage, and use of the personal information data should comply with well-established privacy policies and/or privacy practices.

The foregoing description includes specific details that are not required in order to practice the described embodiments. Rather, the foregoing descriptions of the specific embodiments described herein are presented for purposes of illustration and description. They are not intended to be exhaustive or to limit the embodiments to the precise forms disclosed.

What is claimed is:

1. An eyewear system, comprising:
a first securement arm, a second securement arm, and a lens frame defining an aperture for a lens, the lens frame connected to the first and second securement arms; and
a nose pad connected to the lens frame, the nose pad comprising an adjustable grip enhancement system; and
an actuator that engages the adjustable grip enhancement system in response to a sensed condition.

2. The eyewear system of claim 1, further comprising directional protrusions on the nose pad;
wherein the nose pad is adapted to selectively pivot with respect to the lens frame.

3. The eyewear system of claim 1, the actuator comprising a sensor configured to detect a slip parameter.

4. The eyewear system of claim 1, further comprising:
a protrusion disposed on the nose pad, wherein the actuator selectively extends the protrusion.

5. The eyewear system of claim 1, the adjustable grip enhancement system comprising a woven fabric including polyurethane, polyvinyl chloride, a silicone material, or a shape memory alloy.

6. The eyewear system of claim 1, the adjustable grip enhancement system comprising a polymer including micro-indentation fibrils extending in ridges from a surface of the nose pad.

7. The eyewear system of claim 1, the adjustable grip enhancement system comprising a removable nose pad cover.

8. The eyewear system of claim 1, wherein the adjustable grip enhancement system is integrated with the lens frame.

9. An eyewear system for improved stabilization, comprising:
an optical lens;
a frame supporting the optical lens;
a nose pad connected to the frame;
a sensor configured to monitor an engagement of the nose pad with a nose; and
a grip enhancement system that selectively modifies the eyewear system to grip the nose in response to a signal from the sensor.

10. The eyewear system of claim 9, wherein:
the nose pad comprises a first nose pad and the eyewear system further comprises a second nose pad; and
a spring disposed in the frame, wherein the grip enhancement system causes a pinch force between the first nose pad and the second nose pad, the spring providing a variation in distance between the first nose pad and the second nose pad of between about 2 mm and about 8 mm.

11. The eyewear system of claim 9, the sensor comprising a pressure sensor disposed in the nose pad.

12. The eyewear system of claim 9, the sensor comprising an accelerometer disposed in the frame.

13. The eyewear system of claim 9, the sensor comprising a moisture sensor or a thermal sensor.

14. The eyewear system of claim 9, the sensor comprising an eye tracking camera disposed in the frame.

15. The eyewear system of claim 9, the sensor comprising a counter that determines a number of adjustments of the frame.

16. The eyewear system of claim 9, further comprising an extendable earpiece connected to the frame.

17. An eyewear system, comprising:
an adjustable grip enhancement system, the adjustable grip enhancement system having a first configuration and a second configuration; and
a sensor configured to detect a slip parameter;
wherein the grip enhancement system adjusts from the first configuration to the second configuration in response to the detected slip parameter.

18. The eyewear system of claim 17, further comprising:
a portable electronic device communicatively connected to the grip enhancement system;
wherein the first configuration and the second configuration can be adjusted on the device in response to the detected slip parameter.

19. The eyewear system of claim 18, the portable electronic device further comprising a display configured to indicate when the adjustable grip enhancement system adjusts configurations.

20. The eyewear system of claim 17, wherein the slip parameter comprises a wearer selecting a configuration or a condition detected by the eyewear system.
